(19) United States
(12) Patent Application Publication
(10) Pub. No.: US 2006/0285801 A1
(43) Pub. Date: Dec. 21, 2006

(54) Alignment tool for optical fibers

(75) Inventors: Fumio Aoki, Kawasaki (JP); Shizuo Ishijima, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED., Kawasaki (JP)

(21) Appl. No.: 11/239,284

(22) Filed: Sep. 30, 2005

(30) Foreign Application Priority Data
Jun. 20, 2005 (JP) 2005-179324

(51) Int. Cl. G02B 6/00

(52) U.S. Cl. 385/52; 385/137

(57) ABSTRACT

An alignment tool includes a holding member designed to hold parallel optical fibers. A first movable member is coupled to the holding member for relative movement. The first movable member is designed to hold one of the optical fibers. A second movable member is located for a movement relative to the first movable member. The second movable member is designed to hold another one of the optical fibers. The second movable member is capable of moving relative to the first movable member. The interval can be changed between the optical fibers held on the first and second movable members in response to the relative movement of the second movable member. In this case, the predetermined interval can be kept between the optical fibers on the holding member.

### BACKGROUND OF THE INVENTION

1. Field of the Invention

The present invention relates to an alignment tool capable of aligning parallel optical fibers at a predetermined interval.

The term “interval” is defined as a distance between the centers or centroids of objects throughout the specification and claims.

2. Description of the Prior Art

The sheath or coating layer is removed from a fiber-optic cable over a predetermined length from the tip end of the cable for interconnection of the optical fibers. The fiber-optic cables are put together after removal of the coating layer. Bundles of the fiber-optic cables are then set on a well-known splicer. The splicer serves to melt the tip ends of the optical fibers based on a discharge, for example. This results in the fusion bonding of the opposed tip ends of the optical fibers. The interconnection of the optical fibers is in this manner realized.

The splicer is only allowed to effect a discharge over a limited area within the splicer. If the coating layers are too thick in the bundle, a wider interval is inevitably established between the adjacent optical fibers. Some of the optical fibers are located off the limited area. The splicer cannot in this case be utilized for interconnection of the optical fibers. The optical fibers must manually be connected one by one. It is a troublesome operation. It also takes a longer time.

### SUMMARY OF THE INVENTION

It is accordingly an object of the present invention to provide an alignment tool capable of changing the interval between adjacent optical fibers in a facilitated manner.

According to a first aspect of the present invention, there is provided an alignment tool comprising: a holding member designed to hold parallel optical fibers; a first movable member coupled to the holding member for relative movement, said first movable member designed to hold one of the optical fibers; and a second movable member located for a movement relative to the first movable member, said second movable member designed to hold another one of the optical fibers.

The alignment tool allows the holding member to hold the parallel optical fibers at a predetermined interval. The second movable member functions to hold an optical fiber different from the optical fiber held in the first movable member. The predetermined interval can be established between the optical fibers. The second movable member is capable of moving relative to the first movable member. The interval can be changed between the optical fibers held on the first and second movable members in response to the relative movement of the second movable member. In this case, the predetermined interval can be kept between the optical fibers on the holding member.

According to a second aspect of the present invention, there is provided an alignment tool comprising: a holding member designed to hold parallel optical fibers arranged at a predetermined interval in parallel with a datum line; a rotating body coupled to the holding member for relative rotation around a rotation axis extending within an imaginary plane intersecting the datum line; a curved surface defined on the surface of the rotating body; and grooves formed on the curved surface, the grooves having one ends arranged at the predetermined interval, the grooves extending to the other ends arranged at an interval different from the predetermined interval.

The alignment tool allows the holding member to hold parallel optical fibers arranged at a predetermined interval in parallel with the datum line. The optical fibers are received in the one ends of the grooves. When the rotating body rotates around the rotation axis, the points of contact between the optical fibers and the curved surface moves along the grooves. The points of contact between the curved surface and the optical fibers move from the one ends to the other ends in the grooves. When the points of contact reach the other ends of the grooves, the interval changes between the optical fibers.

According to a third of the present invention, there is provided an alignment tool comprising: a first holding member designed to hold parallel optical fibers along an imaginary plane perpendicular to a reference plane, the first holding member allowing the optical fibers to move relative to the imaginary plane; and a second holding member coupled to the first holding member for relative rotation around a rotation axis intersecting the reference plane.

The alignment tool allows the first holding member to hold parallel optical fibers along the imaginary plane perpendicular to the reference plane. On the other hand, the second holding member is designed to hold the optical fibers at a predetermined interval. When the second holding member rotates around the rotation axis relative to the first holding member, a torsion is induced in the row of the optical fibers. The torsion serves to drive the optical fibers toward the rotation axis on the first holding member. The optical fibers are thus allowed to move along the imaginary plane. The interval can thus be changed between the adjacent optical fibers.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating the structure of an alignment tool according to a first embodiment of the present invention;

FIG. 2 is an enlarged partial perspective view schematically illustrating the structure of movable members;

FIG. 3 is a sectional view, taken along the line 3-3 in FIG. 1, for schematically illustrating the movable members at first positions;

FIG. 4 is a sectional view, corresponding to FIG. 3, for schematically illustrating the movable members at second positions;

FIG. 5 is a plan view schematically illustrating the movable members at the first positions;

FIG. 6 is a plan view schematically illustrating the movable members at the second positions;

FIG. 7 is a perspective view schematically illustrating the alignment tool receiving fiber-optic cables;

FIG. 8 is a plan view schematically illustrating the optical fibers held at first intervals;

FIG. 9 is a plan view schematically illustrating the optical fibers held at the second intervals;

FIG. 10 is a plan view schematically illustrating a splicer realizing fusion bonding between the abutted optical fibers;

FIG. 11 is a perspective view schematically illustrating the structure of an alignment tool according to a second embodiment of the present invention;

FIG. 12 is an enlarged partial perspective view schematically illustrating the fiber-optic cables mounted on the alignment tool according to the second embodiment;

FIG. 13 is an enlarged partial perspective view schematically illustrating the optical fibers put together on a rotating member;

FIG. 14 is a perspective view schematically illustrating the structure of an alignment tool according to a third embodiment of the present invention;

FIG. 15 is a sectional view schematically illustrating the optical fibers held at the first intervals;

FIG. 16 is an enlarged partial side view schematically illustrating a torsion in the row of the optical fibers; and

FIG. 17 is a sectional view schematically illustrating the optical fibers put together or held at the second intervals.

### DESCRIPTION OF THE PREFERRED EMBODIMENTS

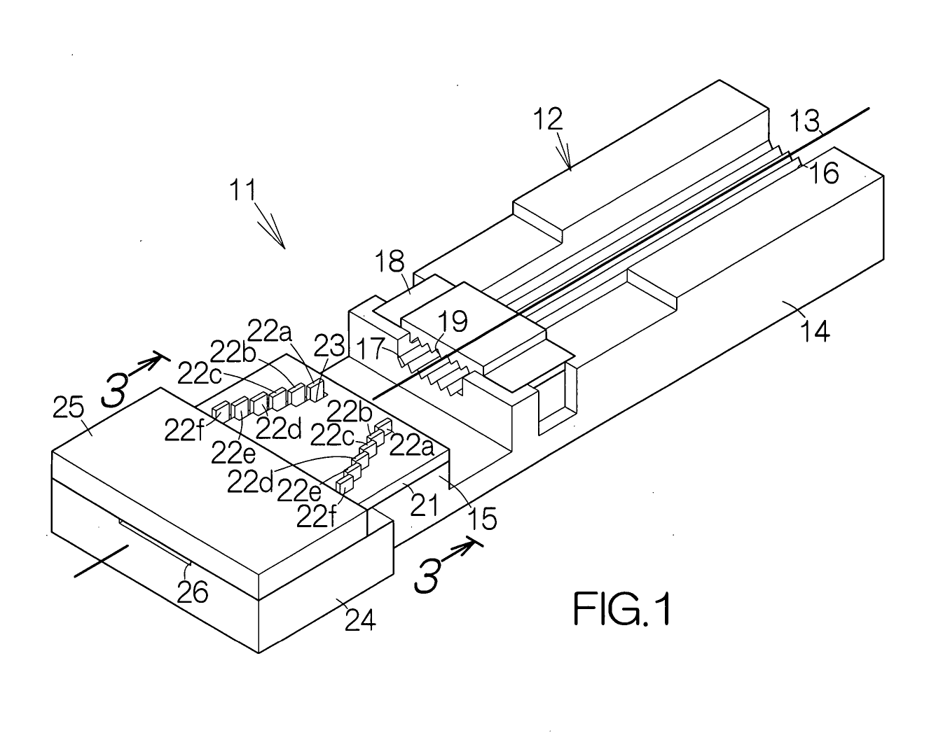

FIG. 1 schematically illustrates the structure of an alignment tool 11 according to a first embodiment of the present invention. The alignment tool 11 includes a holding member 12 in the shape of a parallelepiped, for example. The holding member 12 includes a first or main block 14 and a second or front block 15. The first block 14 is designed to extend in a longitudinal direction along a datum line 13. The second block 15 is opposed to the front end of the first block 14 at a predetermined interval. The first and second blocks 14, 15 may be made of a metallic member, for example.

An elongated groove 16 is formed over the entire length of the first block 14. The elongated groove 16 is designed to extend in a longitudinal direction along the datum line 13. Parallel grooves 17, 17, . . . are formed at the bottom surface of the elongated groove 16. A first holder attachment 18 is placed on the upper surface of the first block 14 at the front end of the elongated groove 16. The first holder attachment 18 lies across the elongated groove 16. The first holder attachment 18 is designed to define parallel grooves 19, 19, . . . on the inward surface opposed to the first block 14. The grooves 19 extend in parallel with the grooves 17 of the elongated groove 16. The grooves 17, 19 may be a notch, for example. The first holder attachment 18 is removably attached on the first block 14 based on magnetic attraction.

A second holder attachment 21 is likewise placed on the upper surface of the second block 15. The second holder attachment 21 is also removably attached on the second block 15 based on magnetic attraction. Six pairs of movable members 22a, 22a, . . . , 22f, 22f are incorporated in the second block 15. The tip ends of the movable members 22a-22f protrude from a pair of openings 23 defined in the second holder attachment 21. The movable members 22a-22f are allowed to move in a direction perpendicular to the datum line 13. The movable members 22a-22f are thus allowed to move relative to the holding member 12.

A front member 24 is attached to the front end of the second block 15. A third holder attachment 25 is placed on the upper surface of the front member 24. The third holder attachment 25 is removably attached on the front member 24 based on magnetic attraction. A receiving groove 26 is formed on the upper surface of the front member 24. The receiving groove 26 extends by a predetermined width in a longitudinal direction along the datum line 13. The third holder attachment 25 covers the receiving groove 26. The front member 24 is removable from the holding member 12 along with the third holder attachment 25.

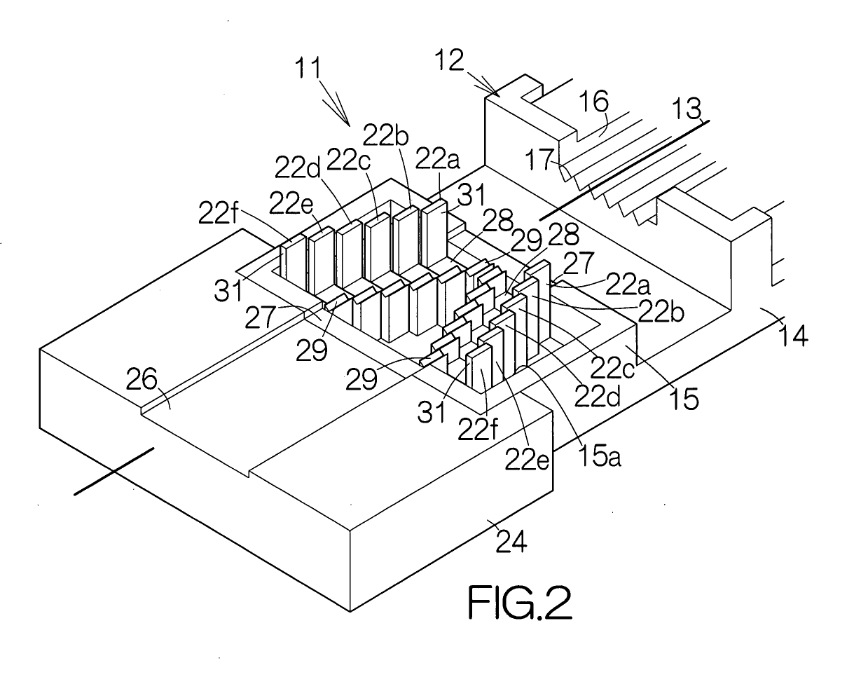

As shown in FIG. 2, the second block 15 includes a surrounding wall defining an inside space 15a. A pair of front and rear receiving grooves 27, 27 is formed on the upper surface of the surrounding wall. The receiving grooves 27 are designed to extend by a predetermined width in the longitudinal direction along the datum line 13. The width of the receiving grooves 27 may correspond to that of the receiving groove 26. The aforementioned second holder attachment 21 covers the receiving grooves 27. The bottom surfaces of the receiving grooves 27 may be aligned with that of the receiving groove 26 within an imaginary plane. The front receiving groove 27 is thus connected to the receiving groove 26. The inside space 15a is located between the front and rear receiving grooves 27 in the second block 15.

Each of the movable members 22a-22f includes a slider 28 movably received within the inside space 15a of the second block 15. The sliders 28 of each pair of the movable members 22a, 22a, . . . , 22f, 22f are allowed to slide on a common straight line perpendicular to the datum line 13. A notch 29 is formed at the inner end of the slider 28. The notches 29 extend in parallel with the datum line 13 over the level aligned with the bottom surfaces of the front and rear receiving grooves 26. An operating piece 31 is formed at the outer end of the slider 28. The operating piece 31 stands upright from the slider 28. The sliders 28 and operating pieces 31 may be made of a resin material such as silicone, acetal (Delrin®), or the like.

As shown in FIG. 3, a predetermined gap is defined between the grooves 29 of the movable members 22a-22f and the second holder attachment 21. The extent of the predetermined gap may depend on the diameter of an optical fiber interposed therebetween. On the other hand, the operating pieces 31 protrude from the openings 23 of the second holder attachment 21. The operator is allowed to manipulate the operating pieces 31 with the fingers, for example. The manipulation causes the sliding movement of the sliders 28, namely the movable members 22a-22f. Here, when the outer surfaces of the operating pieces 31 contact the outer ends of the openings 23, the movable members 22a-22f are positioned at first positions.

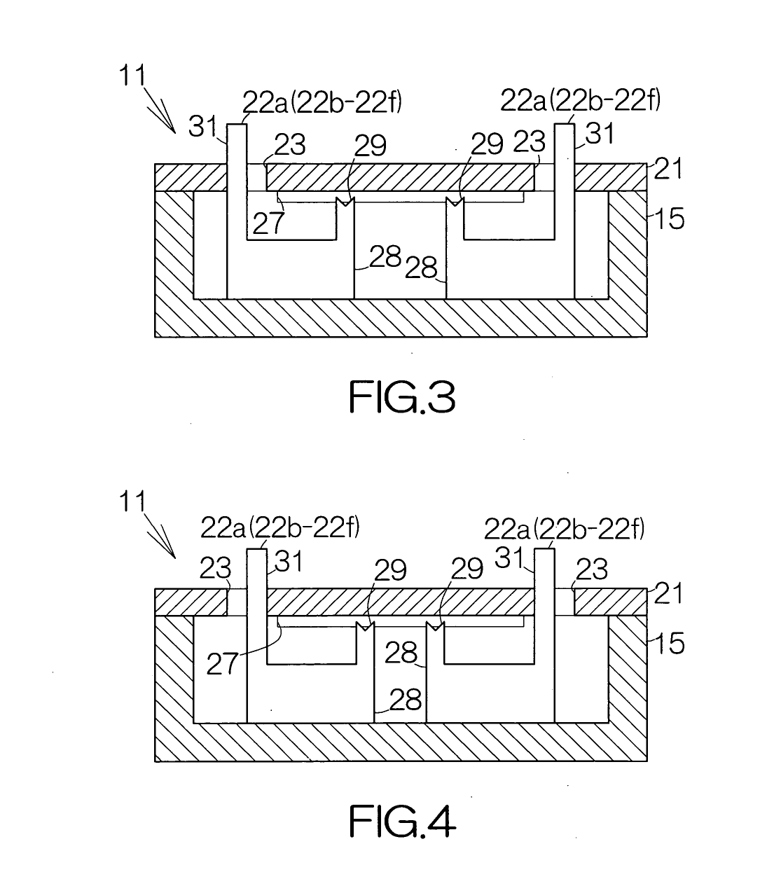

When the operating pieces 31, 31 of the pair move closer to each other along the aforementioned common straight line, the sliders 28 slide along the bottom surface of the inside space 15a. As shown in FIG. 4, the inner surfaces of the operating pieces 31 thus contact the inner ends of the openings 23. The movable members 22a-22f are positioned at second positions. The movable members 22a-22f are in this manner positioned at the first and second positions in a facilitated manner. The movable members 22a-22f are allowed to move relative to each other. Any of the movable members 22a-22f functions as the first or second movable member according to the present invention.

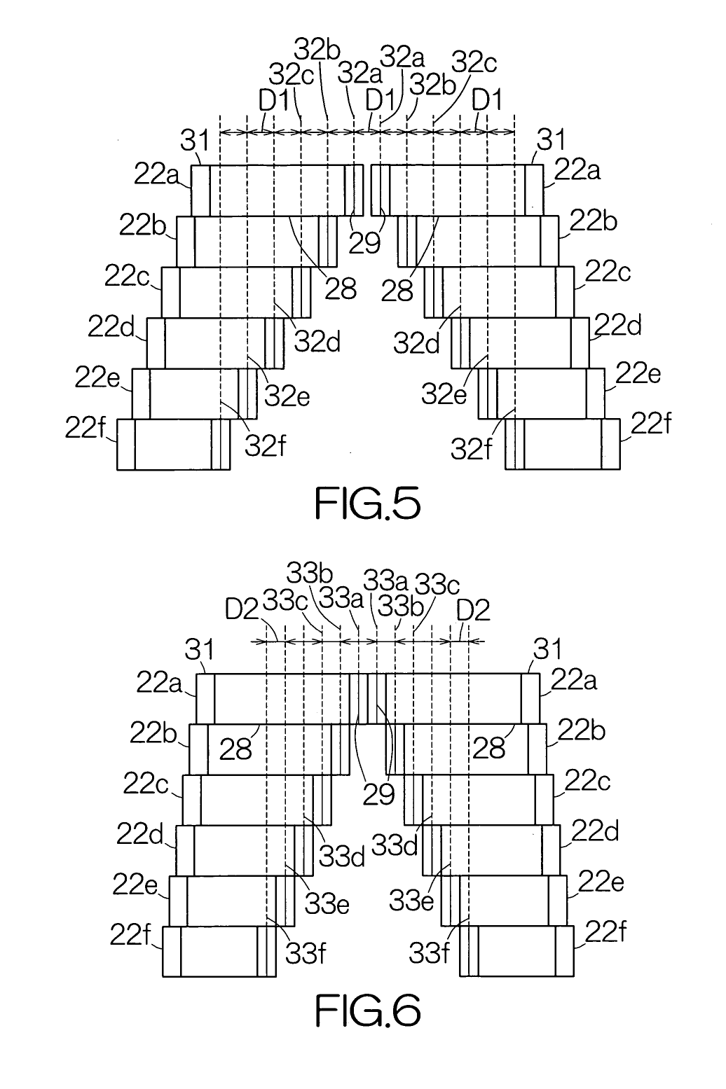

As shown in FIG. 5, six pairs of first imaginary parallel lines 32a, 32a, . . . , 32f, 32f are defined on the second block 15. The first imaginary parallel lines 32a-32f extend in parallel with the datum line 13. A first interval D1 is set between each pair of the adjacent first imaginary parallel lines 32a-32f. When the movable members 22a, 22a are positioned at the first positions, the grooves 29, 29 of the movable members 22a, 22a are respectively positioned on the first imaginary parallel lines 32a, 32a. When the movable members 22b, 22b are positioned at the first positions, the grooves 29, 29 of the movable members 22b, 22b are respectively positioned on the first imaginary parallel lines 32b, 32b immediately outside the first imaginary parallel lines 32a, 32a. Likewise, when the movable members 22c-22f are positioned at the first positions, the grooves 29, 29 of the movable members 22c-22f are respectively positioned on the corresponding first imaginary parallel lines 32c, 32c, 32f, 32f. Here, the first interval D1 corresponds to half the interval between the adjacent parallel grooves 17, 17.

As shown in FIG. 6, six pairs of second imaginary parallel lines 33a, 33a, . . . , 33f, 33f are likewise defined on the second block 15. A second interval D2 smaller than the first interval D1 is set between each pair of the adjacent second imaginary parallel lines 33a-33f. When the movable members 22a, 22a are positioned at the second positions, the grooves 29, 29 of the movable members 22a are respectively positioned on the second imaginary parallel lines 33a, 33a. When the movable members 22b, 22b are positioned at the second positions, the grooves 29, 29 of the movable members 22b are respectively positioned on the second imaginary parallel lines 33b, 33b immediately outside the second imaginary parallel lines 33a, 33a. Likewise, when the movable members 22c-22f are positioned at the second positions, the grooves 29, 29 of the movable members 22c-22f are respectively positioned on the corresponding second imaginary parallel lines 32c, 32c, . . . , 32f, 32f.

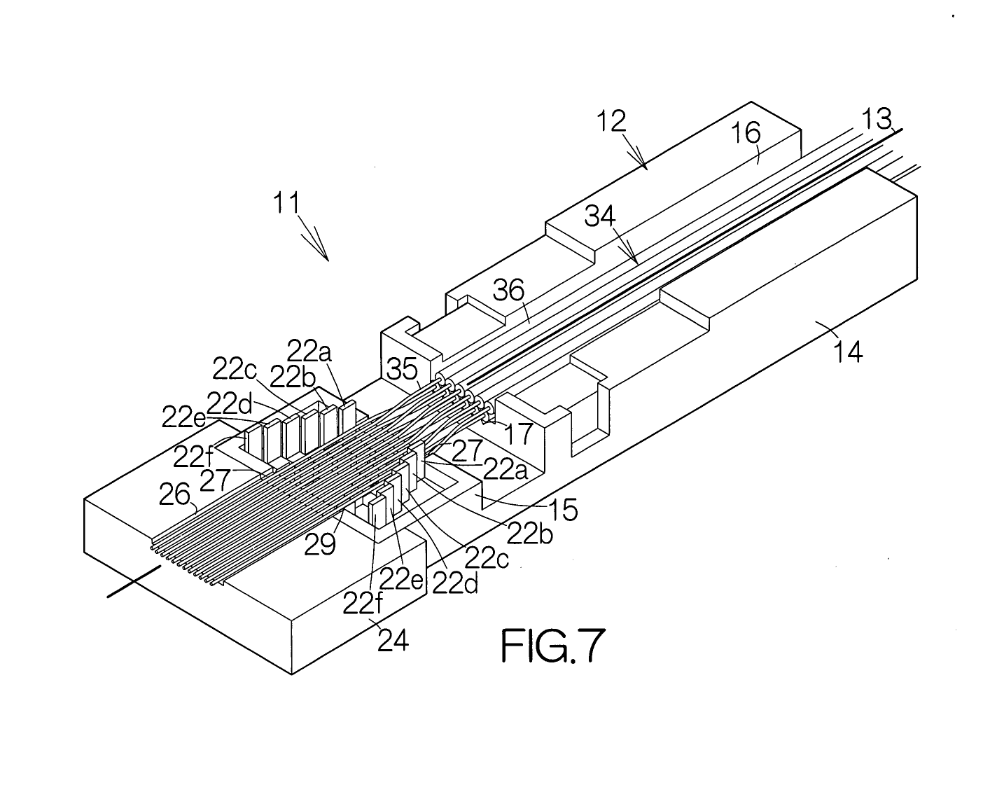

Next, description will be made on a method of coupling the optical fibers based on fusion bonding. Twelve fiber-optic cables 34, 34, . . . , for example, are first set in the elongated groove 16 of the first block 14 as shown in FIG. 7. Each of the fiber-optic cables 34 comprises an optical fiber 35 and a sheath or coating layer 36 surrounding the optical fiber 35. As conventionally known, the optical fiber includes a core and a clad surrounding the core. Here, the outer diameter of the coating layer 36 is set at 0.9 mm, for example. The coating layer 36 has been removed from the fiber-optic cable 34 over a predetermined length from the tip end of the cable 34. The optical fiber 35 of the predetermined length thus protrude out of the tip end of the coating layer 35. The predetermined length may be set at 35 mm approximately, for example.

The fiber-optic cables 34 are arranged in parallel with each other along the datum line 13 within the elongated groove 16. The fiber-optic cables 34 are put together in two tiers. Specifically, six fiber-optic cables 34 are assigned to the upper tier, while six fiber-optic cables 34 are assigned to the lower tier. The fiber-optic cables 34 in the lower tier are respectively received in the corresponding parallel grooves 17. The fiber-optic cables 34 in the upper tier are respectively located in the middle of the adjacent fiber-optic cables 34, 34 in the lower tier. The interval of 0.9 mm is set between the axes of the adjacent optical fibers 35, 35 in the lower tier. The interval reflects the row of the parallel grooves 17. The interval of 0.9 mm is also set between the axes of the adjacent optical fibers 35, 35 in the upper tier. This interval reflects the row of the fiber-optic cables 35 in the lower tier.

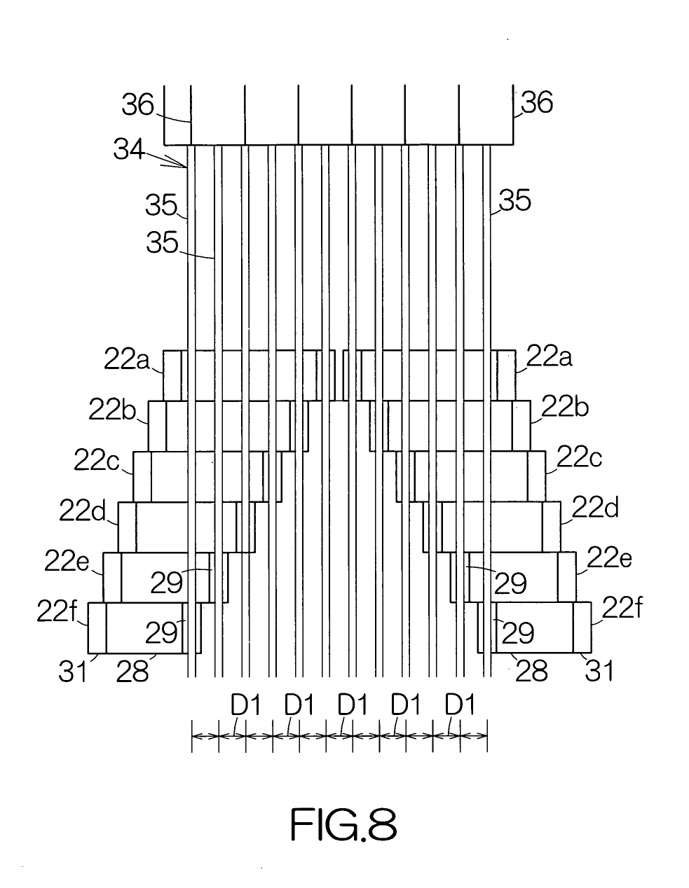

The optical fibers 35 are allowed to reach the front end of the front member 24. The optical fibers 35 are thus received on the bottom surfaces of the receiving groove 26 and the receiving grooves 27, 27. Referring also to FIG. 8, since the fiber-optic cables 34 in the upper tier are respectively located in the middle of the adjacent fiber-optic cables 34 in the lower tier as described above, the optical fibers 35 of the upper and lower tiers are alternately arranged in the receiving grooves 27, 27. The interval of 0.45 mm is thus established between the adjacent optical fibers 35 in the receiving grooves 27, 27. On the other hand, the movable members 22a-22f are positioned at the first positions. Here, the first interval D1 is set at 0.45 mm. The optical fibers 35 are thus respectively received in the notches 29 of the movable members 22a-22f.

The first holder attachment 18 is then set on the first block 14. The parallel grooves 19 of the first holder attachment 18 receive the fiber-optic cables 34 in the upper tier. The fiber-optic cables 34 are in this manner immobilized within the elongated groove 16. The second holder attachment 21 is also mounted on the second block 15. The openings 23 of the second holder attachment 21 receive the insertion of the operating pieces 31 of the movable members 22a-22f. The second holder attachment 21 serves to hold the optical fibers 35 against the notches 29. The second holder attachment 21 prevents crossing between the optical fibers 35 and upward movements of the optical fibers 35. The third holder attachment 25 is also mounted on the front member 24. The third holder attachment 21 serves to prevent crossing between the optical fibers 35 and upward movements of the optical fibers 35.

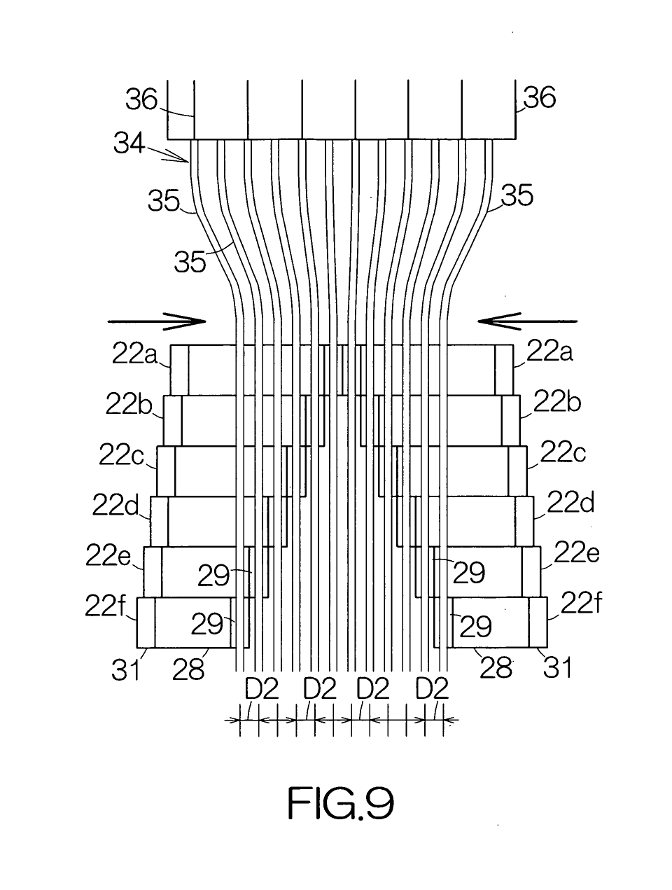

When the operating pieces 31 are operated to move the sliders 28 inward, the movable members 22a-22f move from the first positions to the second positions. When the inner surfaces of the operating pieces 31 contact the inner ends of the openings 23 as described above, the movable members 22a-22f reach the second positions. As shown in FIG. 9, the optical fibers 35 are held at the second intervals D2 based on the sliding movement of the movable members 22a-22f. Here, the second interval D2 is set at 0.25 mm, for example. A transition from the first interval D1 to the second interval D2 is established in the interval between the adjacent optical fibers 35, 35. A gradual change in the interval is absorbed through deformation of the optical fibers 35.

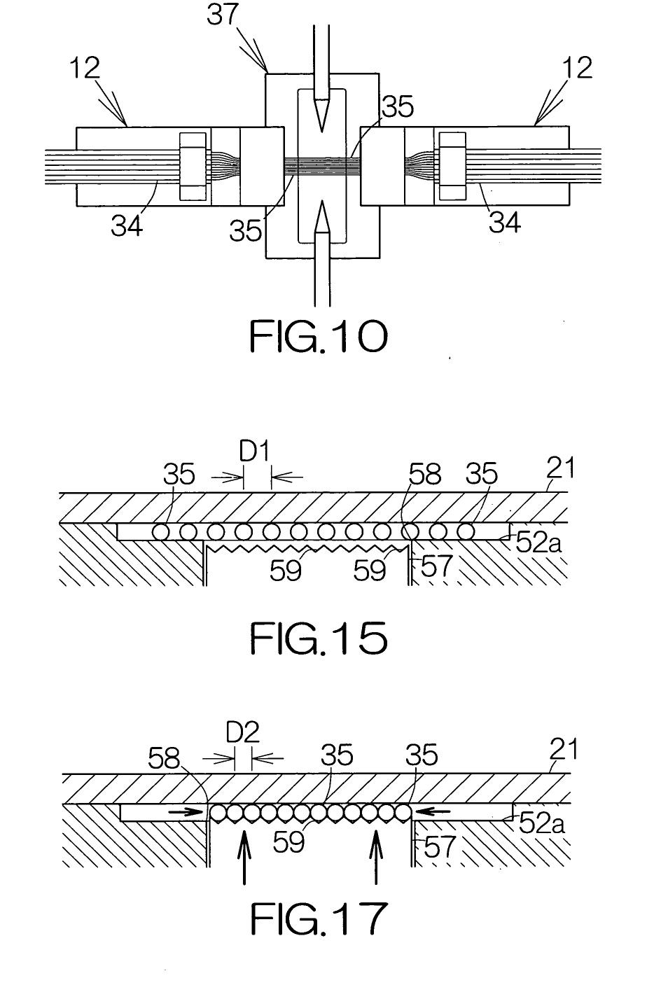

The optical fibers 35 are bonded together with an adhesive, for example, in a space between the first and second blocks 14, 15. The interval between the adjacent optical fibers 35, 35 is thus maintained. The front member 24 is then detached from the holding member 12. The optical fibers 35 are thus allowed to protrude from the front end of the holding member 12. The optical fibers 35 are then cut along a predetermined plane perpendicular to the datum line 13. The tip ends of the optical fibers 35 are in this manner aligned. A conventional cutting tool may be employed. As shown in FIG. 10, a pair of the holding members 12 is then mounted on a splicer 37. The tip ends of the optical fibers 35 on one of the holding members 12 are allowed to abut the tip ends of the optical fibers 35 on the other of the holding members 12. The splicer 37 effects a discharge at the abutted tip ends of the optical fibers 35. The optical fibers 35 are fused together based on the discharge. The optical fibers 35 of the sets are in this manner firmly interconnected together.

The alignment tool 11 allows the movable members 22a-22f to slide from the first positions to the second positions based on the manipulation of the operating pieces 31. The interval between the adjacent optical fibers 35 is allowed to change from the first interval D1 to the second interval D2 in a facilitated manner. The process of fusion bonding can thus be simplified. Moreover, if the holding member 12 is formed in the shape identical to that of a conventional holding member unique to the splicer 37, the holding member 12 is allowed to simply replace the conventional holding member in the splicer 37. It is not necessary to transfer the optical fibers 35 on the holding member 12 to the conventional holding member unique to the splicer 37 after the change of intervals prior to the fusion bonding. This serves to avoid complication of the fusion bonding.

The notches 29 are located on the first imaginary parallel lines 32a-32f at the first intervals D1. The optical fibers 35 are respectively held in the parallel grooves 17 of the elongated groove 16 at the first intervals D1. When the fiber-optic cables 34 are received in the elongated groove 16, the optical fibers 35 are respectively received in the notches 29 of the movable members 22a-22f without changing the intervals between the adjacent optical fibers 35. This results in allowing the operator to mount the optical fibers 35 on the alignment tool 11 without directly touching the optical fibers 35. The optical fibers 35 are thus reliably prevented from damages.

The fiber-optic cables 34 are arranged in tiers. The optical fibers 35 can thus be arranged at a higher density within a narrower space as compared with the case where the fiber-optic cables are arranged in a tier. A larger bend can be avoided in the optical fibers 35. Specifically, the optical fibers 35 are forced to bend only within a range of the permissible radius of curvature when the intervals are changed between the adjacent optical fibers 35. The optical fibers 35 are thus reliably prevented from damages.

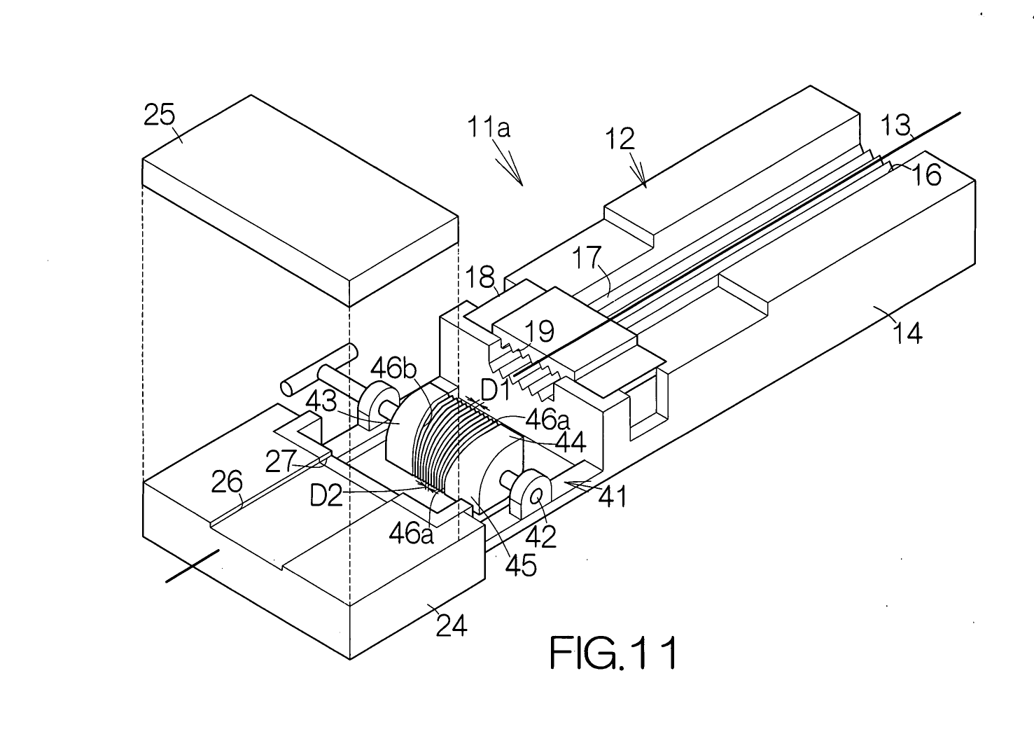

FIG. 11 schematically illustrates the structure of an alignment tool 11a according to a second embodiment of the present invention. The alignment tool 11a includes, in place of the aforementioned second block 15, a rotating body 41 coupled to the holding member 12 in front of the first block 14. The rotating body 41 is supported on the holding member 12 for relative rotation on a rotation shaft 42 extending in the lateral direction across the row of the optical fibers 35. The rotation axis of the rotation shaft 42 is set within an imaginary plane intersecting the datum line 13. The rotation axis crosses the row of the optical fibers 35. Here, the imaginary plane including the rotation axis of the rotation shaft 42 may be set perpendicular to the datum line 13.

The rotating body 41 is spaced from the elongated groove 16 by a predetermined interval. A curved surface 43 is defined on the outer surface of the rotating body 41. The curved surface 43 may be formed by generatrices equidistant from the rotation axis of the rotating shaft 42. The curved surface 43 may extend over the central angle of 90 degrees around the rotation axis of the rotation shaft 42. Here, first and second flat surfaces 44, 45 are couple to the generatrices at the front and rear ends of the curved surface 43. The first and second flat surfaces 44, 45 are designed to extend within imaginary planes tangent to the curved surface 43 at the rear and front ends thereof. The rotating body 41 may be made of a resin material such as silicone, acetal (Delrin®), or the like.

Parallel grooves 46a are formed on the first flat surface 44. The first interval D1 is set between the centroids of the adjacent parallel grooves 46a on the first flat surface 44. Parallel grooves 46a are likewise formed on the second flat surface 45. The second interval D2 is set between the centroids of the adjacent parallel grooves 46a on the second flat surface 45. The parallel grooves 46a on the first flat surface 44 are connected to the parallel grooves 46a on the second flat surface 45 through grooves 46b on the curved surface 43. The grooves 46b on the curved surface 43 have one ends connected to the parallel grooves 46a arranged on the first flat surface at the first intervals D1. The grooves 46b extend to the other ends connected to the parallel grooves 46a arranged on the second flat surface 45 at the second intervals D2. The intervals gradually gets smaller between the centroids of the adjacent grooves 46b at locations closer to the second flat surface 45. The grooves 46a, 46b may be notches, for example. Like reference numerals are attached to the structure or components equivalent to those of the aforementioned first embodiment.

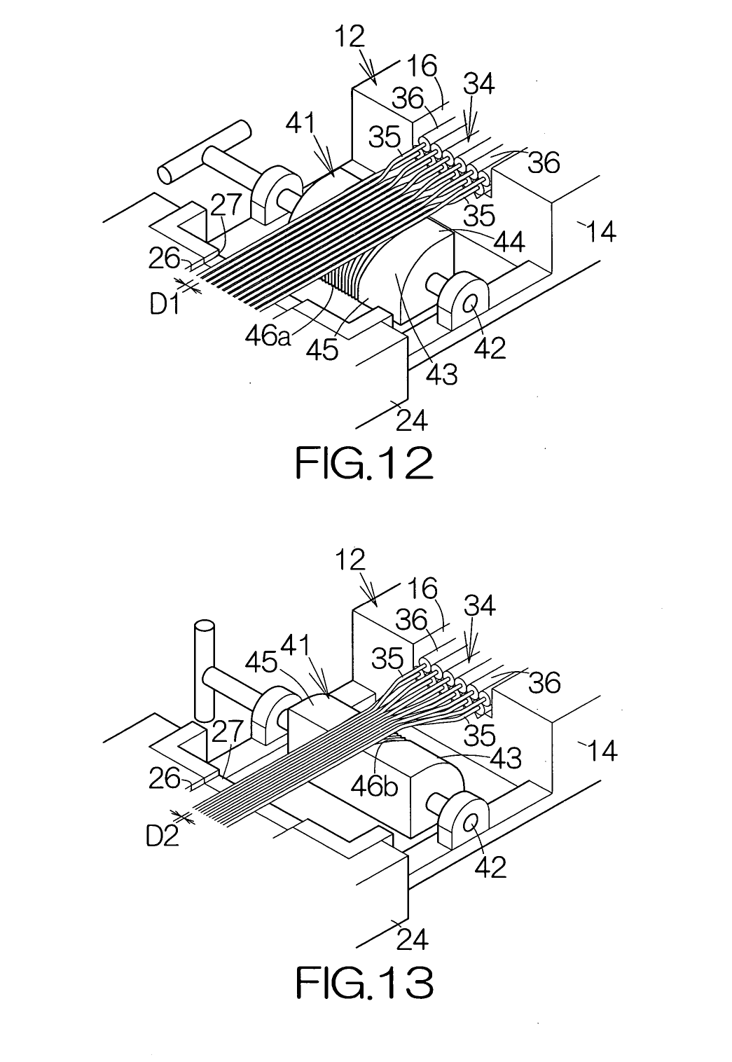

As shown in FIG. 12, the optical fibers 35 are held at the first intervals D1 within the elongated groove 16 as described above. The first interval D1 is set between the centroids of the adjacent parallel grooves 46a on the first flat surface 44 of the rotating body 41. When the fiber-optic cables 34 are received in the elongated groove 16, the optical fibers 35 are accordingly respectively received in the corresponding parallel grooves 46a. The optical fibers 35 are in this manner held on the rotating body 41 at the first intervals D1. The first holder attachment 18 is thereafter mounted on the first block 14. The third holder attachment 25 is also mounted on the front member 24. The optical fibers 35 are held against the parallel grooves 46a at the first flat surface 44 tangent to the curved surface 43. The optical fibers 35 are received on the curved surface 43 at the points of contact.

When the rotating body 41 rotates around the rotation axis of the rotation shaft 42 relative to the first block 15, the points of contact between the optical fibers 35 and the curved surface 43 move along the curved surface 43. In other words, the points of contact between the optical fibers 35 and the curved surface 43 stay at positions right above the rotation shaft 42. The points of contact thus move in the grooves 46b on the curved surface 43 during the rotation of the rotating body 41 around the rotation axis of the rotation shaft 42. The points of contact move from the rear ends near the first flat surface 44 to the front ends near the second flat surface 45. Since the interval gets smaller between the centroids of the adjacent grooves 46b, the interval gradually gets smaller between the adjacent optical fibers 35 from the rear ends to the front ends.

When the rotating body 41 rotates around the rotation axis by 90 degrees, the points of contact reach the second flat surface 45. The second interval D2 is set between the adjacent optical fibers 35, 35, as shown in FIG. 13. The optical fibers 35 are then bonded together with an adhesive, for example, in a space between the elongated groove 16 and the rotating body 41. The front member 24 is thereafter detached from the holding member 12. The optical fibers 35 are thus allowed to protrude from the front end of the holding member 12. The optical fibers 35 are then cut along a predetermined plane perpendicular to the datum line 13. The tip ends of the optical fibers 35 are aligned. A conventional cutting tool may in this case be employed. A pair of the holding members 12 is then mounted on the splicer 37 in the same manner as described above. The splicer 37 is utilized to achieve fusion bonding between the abutted optical fibers 35.

The alignment tool 11a allows movement of the points of contact between the optical fibers 35 and the curved surface 43 from the rear ends of the grooves 46b to the front ends of the grooves 46b in response to the rotation of the rotating body 41. Since the row of the grooves 46b gradually narrows at locations closer to the second flat surface 45, the interval is changed from the first interval D1 to the second interval D2 between the adjacent optical fibers 35 in a facilitated manner. The process of fusion bonding can thus be simplified. Moreover, if the holding member 12 is formed in the shape identical to that of a conventional holding member unique to the splicer 37 as described above, the holding member 12 is allowed to simply replace the conventional holding member in the splicer 37.

Otherwise, the alignment tool 11a may further include a holder attachment, not shown, covering over the rotating body 41. Such a holder attachment is opposed to the first flat surface 44, the curved surface 43 and the second flat surface 45 in response to the rotation of the rotating body 41. A predetermined gap may be established between the holder attachment and the grooves 46a, 46b on the rotating body 41. The dimension of the predetermined gap may depend on the diameter of the optical fibers 35. The holder attachment serves to reliably hold the optical fibers 35 in the grooves 46a, 46b. The interval can thus reliably be narrowed between the adjacent optical fibers 35.

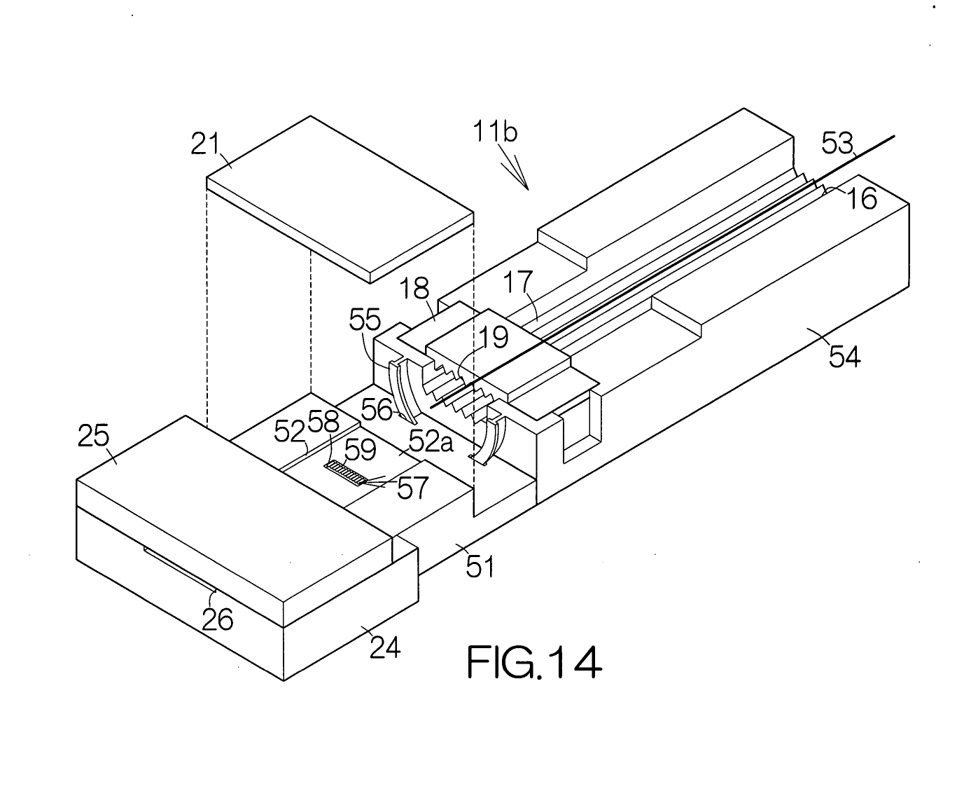

FIG. 14 schematically illustrates the structure of an alignment tool 11b according to a third embodiment of the present invention. The alignment tool 11b includes a first holding member 51. A receiving groove 52 is formed on the upper surface of the first holding member 51. The receiving groove 52 is designed to extend in a longitudinal direction along the first holding member 51. The receiving groove 52 defines a bottom surface 52a. The bottom surface 52a is designed to extend within an imaginary plane perpendicular to a reference plane. The aforementioned second holder attachment 21 is placed on the upper surface of the first holding member 51. The aforementioned front member 24 is attached to the front end of the first holding member 51. The receiving groove 52 is connected to the receiving groove 26 of the front member 24 in the same manner as the aforementioned front groove 27.

A second holding member 54 is coupled to the rear end of the first holding member 51 for relative rotation around a rotation axis 53 perpendicular to the aforementioned reference plane. A guiding rail 55 is formed at the front end of the second holding member 54. The guiding rail 55 is utilized to couple the second holding member 54 with the first holding member 51. The guiding rail 55 is designed to extend along a circle described around the rotation axis 53. The guiding rail 55 is inserted in a guiding groove 56 formed on the first holding member 51. The guiding rail 55 engages with the guiding groove 56 for relative movement around the rotation axis 53.

The aforementioned elongated groove 16 is formed on the second holding member 54. The receiving groove 52 of the first holding member 51 is allowed to extend along an imaginary plane including the elongated groove 16. A predetermined gap is defined between the elongated groove 16 and the receiving groove 52.

A notch member 57 is incorporated in the first holding member 51. The notch member 57 is received in an opening 58 defined in the bottom surface 52a of the receiving groove 52. The notch member 57 is capable of moving in a vertical direction perpendicular to the bottom surface 52a of the receiving groove 52. The notch member 57 is thus allowed to protrude from the opening 58 of the bottom surface 52a. Notches 59, 59, . . . are defined on the notch member 57. The notches 59 are designed to extend in the longitudinal direction along the first holding member 51. Here, the second interval D2 is set between the adjacent notches 59. Like reference numerals are attached to the structure or components equivalent to those of the aforementioned first and second embodiments.

The fiber-optic cables 34, 34, . . . , twelve of those, are received in the elongated groove 16 in the alignment tool 11b. The fiber-optic cables 34 are arranged in upper and lower tiers as described above. The optical fibers 35 are received in the receiving groove 52 of the first holding member 51 as well as in the receiving groove 26 of the front member 24. As shown in FIG. 15, the optical fibers 35 are arranged in parallel with each other along the bottom surface 52a of the receiving groove 52 at the first intervals D1. The notch member 57 completely withdraws from the bottom surface 52a into the opening 58 of the first holding member 51.

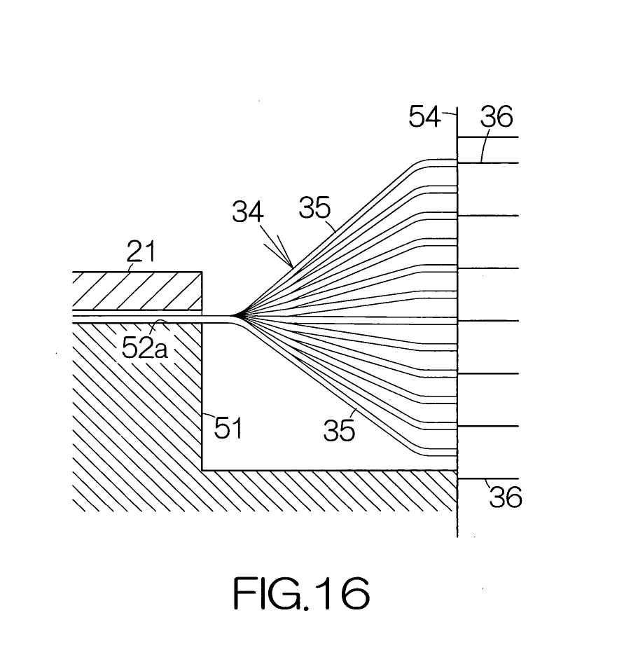

The second holding member 54 is then driven to rotate around the rotation axis 53 relative to the first holding member 51 by a predetermined relative rotation angle. The rotation causes a torsion in the row of the optical fibers 35, as shown in FIG. 16. Since the movement of the optical fibers 35 is guided between the bottom surface 52a of the receiving groove 52 and the second holder attachment 21, the torsion serves to drive the optical fibers 35 toward the rotation axis 53. The optical fibers 35 are thus put together. The intervals between the adjacent optical fibers 53 are reduced to the second interval D2, as shown in FIG. 17. The notch member 57 is thereafter driven to protrude from the bottom surface 52a of the receiving groove 52. The optical fibers 35 are respectively received in the notches 59 of the notch member 57. The optical fibers 35 are thus held at the second intervals D2.

The second holding member 54 is then driven to rotate around the rotation axis 53 by the predetermined relative rotation angle in the reverse direction. The rotation of the second holding member 54 serves to cancel the aforementioned torsion. Here, the notch member 57 still serves to keep the adjacent optical fibers 35 at the second interval D2. The optical fibers 35 are then bonded together with an adhesive, for example, in the gap between the elongated groove 16 and the receiving groove 52. The front member 24 is thereafter detached from the holding member 12. The optical fibers 35 are thus allowed to protrude from the front end of the first holding member 51. The optical fibers 35 are then cut along a predetermined plane perpendicular to the rotation axis 53 in the same manner as described above. The tip ends of the optical fibers 35 are aligned. A conventional cutting tool may be employed. A pair of the first and second holding members 51, 54 is then mounted on the splicer 37. The splicer 37 is utilized to achieve fusion bonding between the abutted optical fibers 35 as described above.

The alignment tool 11b enables establishment of a torsion in the row of the optical fibers 35 based on the rotation of the second holding member 54 relative to the first holding member 51. The torsion serves to drive the optical fibers 35 toward the rotation axis 53. The optical fibers 35 are allowed to move along the bottom surface 52a of the receiving groove 52. The interval between the adjacent optical fibers 35 can thus be changed from the first interval D1 to the second interval D2 in a facilitated manner. The alignment tool 11b of the +third embodiment achieves the advantages identical to those obtained in the aforementioned first and second embodiments.

1. An alignment tool comprising:
a holding member designed to hold parallel optical fibers;
a first movable member coupled to the holding member for relative movement, said first movable member designed to hold one of the optical fibers; and
a second movable member located for a movement relative to the first movable member, said second movable member designed to hold another one of the optical fibers.

2. An alignment tool comprising:
a holding member designed to hold parallel optical fibers arranged at a predetermined interval in parallel with a datum line;
a rotating body coupled to the holding member for relative rotation around a rotation axis extending within an imaginary plane intersecting the datum line;
a curved surface defined on a surface of the rotating body; and
grooves formed on the curved surface, the grooves having one ends arranged at the predetermined interval, the grooves extending to other ends arranged at an interval different from the predetermined interval.

3. An alignment tool comprising:
a first holding member designed to hold parallel optical fibers along an imaginary plane perpendicular to a reference plane, the first holding member allowing the optical fibers to move relative to the imaginary plane; and
a second holding member designed to hold the parallel optical fibers at a predetermined interval, the second holding member being coupled to the first holding member for relative rotation around a rotation axis intersecting the reference plane.
